(19) United States
(12) Patent Application Publication
(10) Pub. No.: US 2026/0292623 A1
(43) Pub. Date: Sep. 24, 2026

(54) METHOD AND APPARATUS FOR MANAGING UE PRIVACY IN WIRELESS COMMUNICATION SYSTEM

(71) Applicant: SAMSUNG ELECTRONICS CO., LTD.., Gyeonggi-do (KR)

(72) Inventors: Selcuk BASSOY, Middlesex (GB); Joan Pujol ROIG, Middlesex (GB); Chadi KHIRALLAH, Middlesex (GB)

(21) Appl. No.: 19/480,278

(22) PCT Filed: Apr. 23, 2024
(86) PCT No.: PCT/KR2024/005455

§ 371 Date: Oct. 30, 2025

(30) Foreign Application Priority Data
May 12, 2023 (GB) 2307093.1
Apr. 12, 2024 (GB) 2405279.7

(51) Int. Cl. H04W 36/00; H04L 41/16; H04W 36/32

(52) U.S. Cl. CPC H04W 36/00835; H04L 41/16; H04W 36/32

(57) ABSTRACT

The disclosure relates to a 5G or 6G communication system for supporting a higher data transmission rate. Disclosed is a method of operating a User Equipment, UE, communicatively coupled to a telecommunication network, wherein the UE is arranged to make certain measurement in relation to the network, and to store the measurement results locally to the UE, wherein the UE is further arranged to not send the measurement results onto the network, thereby preserving privacy associated with the measurement results and to locally perform data analytics, inference or prediction using the measurement results.

### TECHNICAL FIELD

Embodiments disclosed herein relate to wireless communication system (or mobile communication system). More particularly, the disclosure relates to method and apparatus for managing user equipment (UE) policy, specifically UE assisted artificial intelligence (AI) analytics preserving UE policy.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

There are needs to enhance preserving of user security and privacy. Also, there are needs to enhance MDT (minimization of driving test) procedure according to AI model training. Also, there are needs to enhance predicted handover analytics according to AI model.

### Solution to Problem

According to an embodiment of the disclosure, a method performed by a user equipment (UE) is provided. The method comprises: identifying at least one potential target cell for a handover based on mobility analytics information, by performing an artificial intelligence (AI) model inference; transmitting, to a base station, information on a list of the at least one potential target cell for the handover; and receiving, from the base station, information indicating the handover to a target cell among the at least one potential target cell.

According to an embodiment of the disclosure, a user equipment (UE) is provided. The UE comprises: a transceiver; and a controller coupled with the transceiver and configured to: identify at least one potential target cell for a handover based on mobility analytics information, by performing an artificial intelligence (AI) model inference, transmit, to a base station, information on a list of the at least one potential target cell for the handover, and receive, from the base station, information indicating the handover to a target cell among the at least one potential target cell.

According to an embodiment of the disclosure, a method performed by a base station is provided. The method comprises: receiving, from a user equipment (UE), information on a list of at least one potential target cell for a handover, wherein the at least one potential target cell for the handover is based on mobility analytics information for an artificial intelligence (AI) model inference; and transmitting, to the UE, information indicating the handover to a target cell among the at least one potential target cell.

According to an embodiment of the disclosure, a base station is provided. The base station comprises: a transceiver; and a controller coupled with the transceiver and configured to: receive, from a user equipment (UE), information on a list of at least one potential target cell for a handover, wherein the at least one potential target cell for the handover is based on mobility analytics information for an artificial intelligence (AI) model inference, and transmit, to the UE, information indicating the handover to a target cell among the at least one potential target cell.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### Advantageous Effects of Invention

According to various embodiments of the disclosure, preserving of user security and privacy can be efficiently enhanced. Also, according to various embodiments of the disclosure, MDT procedure can be efficiently enhanced according to AI model training. Also, according to various embodiments of the disclosure, predicted handover analytics can be efficiently performed according to AI model training.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the following drawings. Embodiments herein are illustrated by way of examples in the accompanying drawings, and in which:

FIG. 1 illustrates an example of coordination for management data analytics (MDA) function in accordance with an embodiment of the disclosure;

FIG. 2 illustrates an example of signaling for local model training at UE in accordance with an embodiment of the disclosure;

FIG. 3 illustrates an example of signaling for model delivery and analytics configuration at UE in accordance with an embodiment of the disclosure;

FIG. 4 is a block diagram showing a structure of a terminal according to an embodiment of the disclosure;

FIG. 5 is a block diagram showing a structure of a base station according to an embodiment of the disclosure; and

FIG. 6 is a block diagram showing a structure of a network entity (or, a network function) according to an embodiment of the disclosure.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

The various embodiments discussed below for describing the principles of the disclosure in the patent document are for illustration only and should not be interpreted as limiting the scope of the disclosure in any way. Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the present application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the present application can be applied to future-oriented communication technologies. In addition, the technical schemes of the embodiments of the present application can be applied to future-oriented communication technologies.

Hereinafter, embodiments of the disclosure will be described in detail with reference to the accompanying drawings. It should be noted that the same reference numerals in different drawings will be used to refer to the same elements already described.

The present invention relates to method for ensuring privacy of certain data within a telecommunication system. It further relates to improved performance of a User Equipment, UE, via use of on-device Artificial Intelligence, AI, techniques.

Artificial Intelligence (AI) based data analytics is a significantly important function in current Fifth Generation (5G) networks and key enabler for Sixth Generation (6G). 3GPP has proposed a network data analytics function (NWDAF) which collects data from various network functions based on subscriptions to events and provides analytics service to any network functions and the Operations and Management (OAM) function. The list of Network Function (NF) services provided by NWDAF is provide in Table 1, below:

TABLE 1

| | Service | Operation | |
|---|---|---|---|
| Service Name | Operations | Semantics | Example Consumer(s) |
| Nnwdaf_AnalyticsSubscription | Subscribe | Subscribe/Notify | PCF, NSSF, AMF, SMF, NEF, |
| | | | AF, OAM, CEF, NWDAF, |
| | | | DCCF |
| | Unsubscribe | | PCF, NSSF, AMF, SMF, NEF, |
| | | | AF, OAM, CEF, NWDAF, |
| | | | DCCF |
| | Notify | | PCF, NSSF, AMF, SMF, NEF, |
| | | | AF, OAM, CEF, NWDAF, |
| | | | DCCF, MFAF |
| | Transfer | Request/Response | NWDAF |
| Nnwdaf_AnalyticsInfo | Request | Request/Response | PCF, NSSF, AMF, SMF, NEF, |
| | | | AF, OAM, CEF, NWDAF, |
| | | | DCCF |
| | ContextTransfer | Request/Response | NWDAF |
| Nnwdaf_DataManagement | Subscribe | Subscribe/Notify | NWDAF, DCCF |
| | Notify | | NWDAF, DCCF, MFAF, ADRF |
| | Fetch | Request/Response | NWDAF, DCCF, MFAF, ADRF |
| Nnwdaf_MLModelProvision | Subscribe | Subscribe/Notify | NWDAF |
| | Unsubscribe | | NWDAF |
| | Notify | | NWDAF |
| Nnwdaf_MLModelInfo | Request | Request/Response | NWDAF |

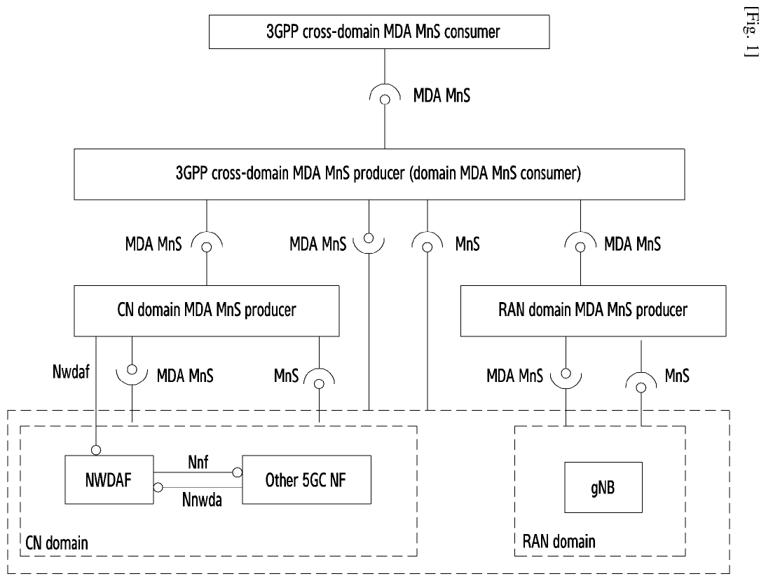

Additionally, 3GPP defined a management data analytics (MDA) function which provides analytics service based on input data from different network functions e.g. data reported from a base station (gNB) and/or specific core network functions. MDA can use the analytics from NWDAF depending on the use cases. MDA can act as cross-domain (Radio Access Network (RAN) and Core) MDA management service (MnS) producer e.g. coordinating data analytics between NWDAF, gNB and MDA MnS producer(s) in different sub-domains as illustrated in FIG. 1 which shows an example of coordination between NWDAF, gNB and MDAS (MDA MnS) producer.

There is currently work ongoing to optimize Minimization of Drive Tests (MDT) for data collection in AI/ML systems.

User-centric network is a key enabler for 6G, and it requires extensive User Equipment (UE) level data analytics to be able to provision network optimisation at the UE level. UE data analytics predicting UE behaviour is important to support a number of use cases like energy efficiency, load balancing, handover prediction and anomaly detection in fully autonomous 6G network. A number of use cases based on UE related analytics are identified for NWDAF in 3GPP, such as UE mobility prediction where UE location is predicted at tracking area (TA) or cell level or abnormal behaviours related network data analytics. Further UE behaviour/service analytics use cases such as NWDAF-assisted Radio Access Technology (RAT)/frequency selection and detection of anomaly events are introduced.

An important enabler for detailed user level analytics is the availability of user specific radio measurements. 3GPP proposes collection of UE specific radio measurements using minimisation of drive test (MDT) procedures. Logged MDT procedure is used to collect UE measurement in RRC_INACTIVE and RRC_IDLE mode and immediate MDT is used to report measurements in RRC-CONNECTED mode. However, MDT measurement collection provides user specific information to the network. Due to privacy and legal requirements, user consent is required before activating MDT for a specific International Mobile Subscriber Identifier (IMSI) or International Mobile Equipment Identifier (IMEI) number.

Embodiments of the invention aim to address the above problem on preserving user privacy, private information safety and security concerns and need for user consent. Other problems, whether identified herein or not are also addressed.

According to the present invention there is provided an apparatus and method as set forth in the appended claims. Other features of the invention will be apparent from the dependent claims, and the description which follows.

According to a first aspect of the invention, there is provided a method of operating a User Equipment, UE, communicatively coupled to a telecommunication network, wherein the UE is arranged to make certain measurement in relation to the network, and to store the measurement results locally to the UE, wherein the UE is further arranged to not send the measurement results onto the network, thereby preserving privacy associated with the measurement results and to locally perform data analytics, inference or prediction using the measurement results.

In an embodiment, the analytics are obtained using an Artificial Intelligence, AI, model that is trained locally to the UE or globally by the network, but using local measurement data.

In an embodiment, the measurements include Minimization of Drive Tests, MDT, data.

In an embodiment, the UE is configured by the network to generate particular analytics reports by providing one or more of specific configurations, parameters, conditions and policies, to assist the UE in the generation of data analytics.

In an embodiment, the particular analytics reports include one of particular measurements, particular analytics and particular inference and predictions.

In an embodiment, the network provides the UE with assistance information on a validity time.

In an embodiment, the network provides information on requirements of the data analytics for the UE, said requirements including one or more of: size of data analytics, latency of data analytics, security requirements, accuracy and Key Performance Indicators, KPIs.

In an embodiment, the network may activate/deactivate or start, pause or stop the data analytics process at the UE.

In an embodiment, the UE utilises a communication module arranged to enable the UE, or a group of UEs, to share securely the generated data analytics reports to the network without sharing raw user data, thus preserving user privacy.

In an embodiment, the UE provides user consent to the network in connection with collecting analytics from the UE or sharing analytics beyond the UE.

In an embodiment, the UE indicates to the network its capability to support analytics to the network, such that the network is able to configure the data analytics collection and reporting, taking into consideration the indicated capability.

According to a second aspect of the invention, there is provided a method of operating a telecommunication network including the step of configuring a UE to locally perform data analytics using certain measurement results, and to share a resulting data analytics report with the network without compromising user privacy.

In an embodiment, there is further provided the use of a module to receive data analytics reports from the UE.

According to a third aspect of the invention, there is provided a UE arranged to perform the method of the first aspect.

According to a fourth aspect of the invention, there is provided a telecommunication network arranged to perform the method of the second aspect.

Embodiments of the present invention address problems in the prior art by introducing a new network function responsible for handling (e.g. producing, controlling, reporting, etc.) the user analytics at the UE. These analytics are obtained using a UE-side AI model(s) that is trained locally (using local data set(s)) or globally by the network (and/or externally (server, other)), based on MDT measurements and any other user specific information, for example, precise location etc.

The present invention provides a novel method and system for implementing privacy-preserving data analytics in 6G user-centric networks. By deploying AI/ML models at the UE level and generating analytics reports without sharing raw user data (or sensitive user data or information), user privacy is maintained and the need for user consent in measurement collection is potentially eliminated. In other words, the user data is kept at the UE and only analytics of this data (or some form of data representation, reshaping, reformulation, randomization, anonymization, and/or other format of the actual data or information) is shared with the network. For example, the analytics (i.e. all or part of the analytics maybe shared with at least one network entity (or network function). This entity (or function) can be a newly defined entity (or function) or existing entity (or function).

Embodiments of the invention provide a method to provide user level analytics reporting from the UE to the network to enable more intelligent user-centric optimization decisions for a fully autonomous user-centric network. A key feature of embodiments of the invention is the ability to use key information from the UE, such as precise location, speed as well as collected measurements and produce accurate analytics reports while preserving the UE privacy, i.e. not sending UE data itself to the network but sending analytics reports only.

Embodiments of the invention provide AI models residing at the UE and utilize sensitive UE information such as precise location information alongside measured network data to provide UE level analytics to the network when required while preserving user privacy. Methods also relate to how such AI models can be trained and analytics reports can be exchanged with the network using trained models inference. Multiple analytics report cases are also introduced alongside with their sample reporting criteria.

Although a few preferred embodiments of the present invention have been shown and described, it will be appreciated by those skilled in the art that various changes and modifications might be made without departing from the scope of the invention, as defined in the appended claims.

For a better understanding of the invention, and to show how embodiments of the same may be carried into effect, reference will now be made, by way of example only, to the accompanying diagrammatic drawings in which:

FIG. 1 shows an example of coordination between NWDAF, gNB and MDAS (MDA MnS) producer, according to an embodiment of the invention;

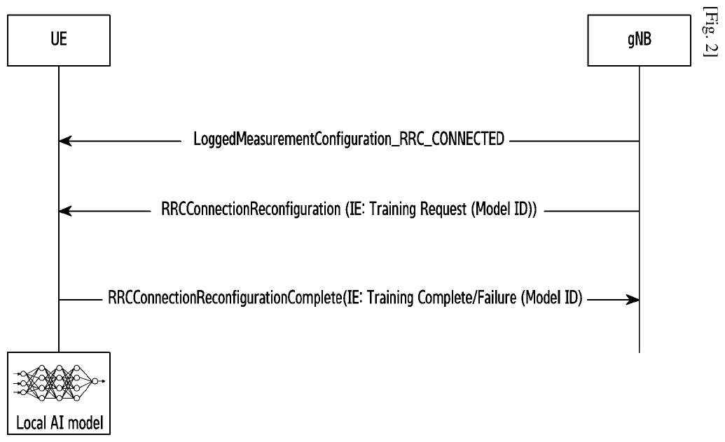

FIG. 2 shows example Signaling for Local Model Training at UE according to an embodiment of the invention; and

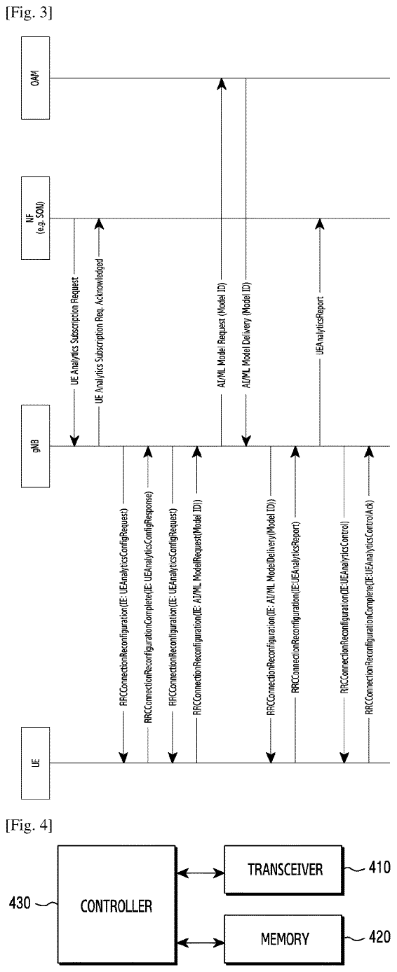

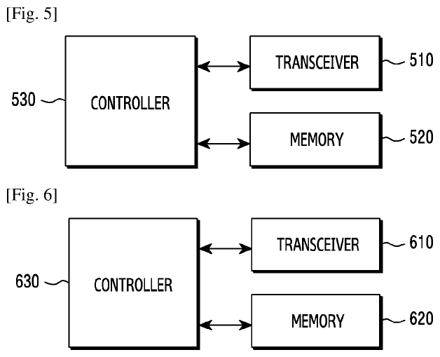

FIG. 3 shows example Signaling for Model Delivery and Analytics Configuration at UE according to an embodiment of the invention.

Embodiments of the present invention comprise one or more of the following features:
a) A trained AI/ML model that is capable of performing data analytics based on the specific user data available at the UE level. This model is deployed at the UE and can be fetched (or requested or downloaded) from the network.
b) A data analytics function located at the UE that uses the deployed AI/ML model to analyze user data and generate analytics reports.
c) The network configures the UE to generate analytics reports using the data analytics function.
d) The network may provide other assistance information to assist the UE (and/or data analytics function) in generating data analytics.
e) The network may provide specific configurations, parameters, conditions, policies, and/or other information to help in the generation of data analytics. In related example, the network provide information related to the use case (or deployment scenario, model functionality, or other information) on which the UE need to provide (or generate analytics).
f) The network may provide assistance information on the validity time
g) (and/or location/area) of the generated data analytics. For example, the validity time a given set of analytics in a given cell/tracking area.
h) The network provides information on the requirements of data analytics for the UE (and/or data analytics function). For example, size of data analytics, latency of data analytics (or End-to-End delays), security requirements, accuracy, Key Performance Indicators (KPIs), other requirements.
i) The network may also activate/deactivate or start, pause or stop data analytics process at the UE. For example, the network (e.g. gNB or NG-RAN) sends a message to start the data analytics procedure in the UE. Additionally, the network (e.g. gNB or NG-RAN) may include information related to the data analytics (as mentioned above) and/or data analytics session ID. For example, the start, pause or stop could be indicated using a flag (included in an existing or newly defined RRC message) or a new IE (DataAnalytics IE=Enumerated {start, pause, stop, . . . }, or Enumerated {activate, deactivate, . . . }, or Data Analytics Activation IE, Data Analytics Deactivation IE, etc. In another example, the indication can be in a newly defined RRC messages, Data Analytics Start Indication or Data Analytics Stop Indication, or Data Analytics Activation or Data Analytics Deactivation, other.
j) The network may indicate the UE (or group of UEs) the failure of a given Data Analytics Session (or procedure) to the UE and/or other network entities (or functions). This indication may include the session ID and/or other assistance information related to this session. Additionally, the network may include a new cause value of the failure, a has failed for a UE.
k) A communication module that enables the UE (or a group of UEs) to share securely the generated data analytics reports to the network without sharing raw user data, thus preserving user privacy.
l) A network-side module that receives and processes the analytics reports, allowing the network to benefit from UE-level data analytics without compromising user privacy.
m) A enhanced MDT procedure (or any other user measurements) that takes advantage of the privacy-preserving data analytics function at the UE level, eliminating (fully or partially or in some cases) the need for the network to obtain (or request or have as preconfigured) user consent to request and/or handle AI/ML data and/or measurements and enabling a wider range of UEs to participate in AI/ML measurements collection.
n) The network and UE (or group of UEs) can exchange the generated data analytic using
   Existing RRC (and/or NAS) signaling/messages, IEs, and/or via system information broadcast (periodic and/or on-demand) or
   Newly defined RRC (and/or NAS) signaling/message, IEs, and/or via system information broadcast (periodic and/or on-demand) and/or newly defined SIBs, other.
   A mix of the above.

Note that throughout this application, step order and name only show one example of the of possible a number of solutions, method or procedure. In another example, other steps maybe added, modified, removed, and/or their order is changed. Additionally, all steps and/or message names may be replaced with other suitable names without changing the inherent meaning.

Certain embodiments relate to user consent related to analytics:
In one embodiment, the network may not require to obtain a user consent for a given set of analytics (or other form of data collected at the UE) or part of the analytics, before requesting the analytics from the UE (or group of UEs) at a given time and/or location.
In another related embodiment, the network may require to obtain user consent for a given set of analytics (or other form of data collected at the UE) or part of the analytics, before requesting the analytics from the UE (or group of UEs) at a given time and/or location.
In another example, the network entity (or network function) may require to obtain a user consent on sharing the analytics with another network entity (or network function).
In another example, the network entity (or network function) may require to obtain a user consent on handling or processing (including extraction of information or update or modification of information, etc.) user analytics.
In another example, the network entity (or network function), that acquired the user analytics from the desired UE (or group of UEs), may verify (or request) the presence (or availability or existence) of user consent, for handling theses analytics, from at least another entity (or function). For example, target entity (e.g. target gNB, NG-RAN, eNB, other Core network entities or functions), before forwarding these analytics to target entity (or function).

Certain other embodiments relate to UE capabilities related to data analytics:
In one embodiment, the UE indicates its capability to support data analytics to the network.
In another embodiment, the UE indicates it capability to support data analytics for a given use case, data type, configuration, scenarios, other.
In one example, the UE capability to support data analytics can be exchanged with the network during initial access and/or provided to the network at a later stage, based on (or following) a request from the network.

Embodiments of the invention assume an enhanced version of MDT measurements (or any other user measurements) enabled at the UE, where the UE records and stores historical MDT measurement data. Enhanced MDT measurements are initiated with a measurement configuration message for example “LoggedMeasurementConfguration_RRC_Connected” message (or any other suitable message or Information Element, IE) sent from gNB to the UE(s) as shown in FIG. 2. Here, AI model training at the UE is not limited to enhanced MDT measurements in RRC_CONNECTED state, but it may also involve any other UE measurements e.g. logged measurements in RRC_IDLE and RRC-INACTIVE states or precise location information and UE speed.

In embodiments of this invention, a data analytics function located at the UE is provided, where AI models can be trained locally using only the UE's data. An example of signaling for AI model training at the UE using local data is illustrated in FIG. 2.

When needed, the gNB can instruct individual UEs or groups of UEs with specific common attributes (such as geographical area, estimated speed, service type, etc.) to train certain AI models in order to generate specific analytics information. Upon receiving the model training request (including specific Model ID) from the gNB, the UE initiates the training process using its locally stored measurement data. Once the training is completed or fails for any reason, the UE sends a “training complete/failure” report back to the gNB (for example via RRC signaling or new signalling). Training failure may include a cause value for example “Not supported” (or any other cause values).

Alternatively, AI models providing user-level analytics can be trained at a dedicated Network Function (NF) or a new logical entity using multiple UE data to achieve globally trained models. To train such global models, user data from UEs where consent is obtained can be used at this NF or logical entity to train models centrally. Additionally, Federated Learning (FL) techniques can be used to train a global model while preserving user privacy. This NF or logical entity can coordinate FL with a selection of UEs, where each UE uses its own data to train a local model and exchange model parameters with the NF or logical entity to update a global model. This way, UEs do not have to share actual data and hence preserve privacy while training a global model.

In embodiments of this invention, the UE(s) may utilize locally trained models or request/download globally trained models from an existing or new NF or logical unit using OAM for inference. A procedure for configuring UE analytics reporting using RRC messages, creating new IE within an existing RRC message or new messages is provided. This enables user privacy preservation, as the local UE data required for inference stays at the UE, and only analytics information is shared with the network. In this way, globally trained models can be used by UEs that do not give consent for sharing their data with the network. Any network function may subscribe to UE analytics data generated from the UE and request the gNB to configure UE analytics reporting for a group of selected UEs. For example, an AI solution residing at the gNB (e.g., load balancing or energy saving) may require UE analytics for AI-assisted improved automated decisions.

Below is an example procedure/message exchange protocol for configuring UE analytics reporting using RRC messages:
1) NF Subscription:
a) The network function (e.g., AI for energy saving) sends a subscription request to the gNB, specifying the desired UE analytics data and a group of UEs based on common attributes (geographical area, estimated speed, service type, etc.).
b) The gNB acknowledges the subscription request.
2) Model Training or Downloading:
a) If the UE requires a globally trained model, it requests the model from the network using OAM, referring to a specific model using a “Model ID”.
b) The network sends the model to the UE.
c) If the UE requires a locally trained model, it trains the model using its locally stored measurement data.
3) RRC Connection Reconfiguration for Analytics Reporting:
a) The network (e.g., gNB or NG-RAN) initiates the configuration process by sending an RRC message (e.g., RRCConnectionReconfiguration or another newly defined message) to the selected UE(s). This message includes a new information element (IE), such as “UEAnalyticsConfigRequest” or another newly defined IE name, which contains details about:
i) Desired Data analytics IDs.
ii) Reporting configurations, such as periodic or event-triggered reporting.
iii) Model parameters (e.g., globally trained model identifier or local training requirements).
iv) Use case information.
v) Validity time and location/area constraints.
vi) Size and latency requirements.
vii) Security requirements.
viii) Desired accuracy or other performance metrics.
ix) KPIs.
x) Any other relevant parameters or assistance information.
b) Upon receiving the RRC message, the UE acknowledges the configuration by sending an RRC message (e.g., RRCConnectionReconfigurationComplete or another newly defined message) back to the gNB. This message includes a new IE, such as “UEAnalyticsConfigResponse” or another suitable IE, which contains the UE's capabilities for supporting the requested analytics reporting configuration, such as supported AI/ML models, reporting triggers, and compliance with the specified requirements.
c) Based on the UE's capabilities reported in the previous step, the network may send a new or updated “RRCConnectionReconfiguration” message (or another newly defined message) to the UE to finalize the analytics reporting configuration. This message may include an updated “UEAnalyticsConfigRequest” IE (or another suitable IE) with adjusted reporting parameters, specific instructions for initiating AI/ML model training, fetching the required model(s), or initiating analytics reporting, and any updated assistance information.
4) Analytics Generation:
a) The UE starts generating analytics reports based on the received configuration instructions, taking into account the specified use case, validity time, location/area, and other requirements.
b) Depending on the configuration, the UE may initiate AI/ML model training, fetch the required model(s) from the network or an external source, or directly start analyzing local user data.
c) The UE generates the requested analytics using either the locally trained model or the downloaded globally trained model.
d) The UE stores the generated analytics locally and prepares them for reporting.
5) Analytics Reporting:
a) Based on the specified reporting configuration, the UE sends the generated analytics to the gNB using an RRC message (or another newly defined message), such as a new IE: “UEAnalyticsReport” (or any other suitable IE name), including:
i) Data Analytics ID.
ii) Timestamp of the generated analytics.
iii) The generated analytics data.
b) The network (e.g., gNB, NG-RAN) processes the received analytics and shares the information with the subscribed network function.
6) If the network needs to modify the analytics reporting configuration, it can send an updated message, such as “RRCConnectionReconfiguration” or another suitable message, with a new or modified IE, such as “UEAnalyticsConfigRequest”, to the UE.
7) The UE responds with a new message, such as “RRCConnectionReconfigurationComplete” or another suitable message, containing an updated IE, such as “UEAnalyticsConfigResponse”, to acknowledge the updated configuration.
8) The network can also send control messages by including a new IE, such as “UEAnalyticsControl” or another suitable IE, in the “RRCConnectionReconfiguration” message (or another newly defined message), to activate, deactivate, start, pause, or stop the data analytics process at the UE.
9) The UE responds with a corresponding acknowledgment message, “RRCConnectionReconfigurationComplete” (or another newly defined message), containing a new IE ACK message, such as “UEAnalyticsControlAck” or another suitable IE name.
10) Decision-making by Network Function: The network function utilizes the received analytics for AI-assisted decision-making in SON use cases, such as load balancing or energy efficiency.

This detailed procedure set out above ensures that only analytics information is shared with the network while preserving user privacy, as the local UE data required for inference remains at the UE. This example message exchange procedure is depicted in FIG. 3.

With the use of embodiments of this invention, UE analytics generated from the UE can be used in any NF or logical function in the network to make enhanced decisions. In the following, example use cases are provided where UE analytics generated from UE can significantly improve decisions of network functions.

An AI model at the UE can predict required handover (HO) earlier, making use of learnt UE behaviour from a trained AI model, the local MDT measurements, UE speed and precise UE location. The AI model can predict HO performance (failure rate) and the expected Quality of Service (QoS) for the UE at each potential target cell based on historical performance of the UE used for training. In the case of globally trained model, trained model will learn from other UEs with the similar behaviour (location, speed, 5G QoS Identifier (5QI) etc). Predicting the handover earlier can increase the handover success rate as HO procedure can be initiated earlier. Moreover, predicted handover analytics produce target cells taking into account predicted UE QoS will help maintain and improve UE QoS at the target cell after the handover, avoiding any degradation as a result of the handover. Additionally, it can prevent ping-pong handovers for high speed UEs where the predicted time on the target cell is very short (i.e. a small cell target is not selected for handover).

In an embodiment, only the list of potential target cell IDs are shared with the network but other information like local MDT measurement, UE speed and precise location and expected QoS etc are not shared with the network but used for AI model inference within the UE to produce target cells for handover. Consequently, UE privacy is respected while making use of the UE specific data for handover prediction.

UEs can be configured to perform model inference periodically or based on a triggering criteria such as source cell Reference Signal Received Power (RSRP)<threshold. The UE can then report back analytics information to the network based on a separate triggering criteria e.g. whenever there is an expected handover. Analytics report can include a list of target cells for handover.

When a cell is highly loaded, one goal is to offload some of the UEs to lightly loaded cells for load balancing. It is often a difficult task to decide for which UEs to initiate handover to relevant target cells, where the target cells are not highly loaded and can still satisfy the QoS requirements for the UEs.

When the cell load is above a threshold, the cell can enable mobility analytics for all UEs connected to the cell using the procedure defined earlier. Mobility analytics can include potential target cells for the UE which can satisfy QoS requirements but not necessarily the best serving cell. Target cells are identified based on UE analytics at the UE, using UE current/predicted location, speed, 5QI and QoS demand and learnt predicted QoS and predicted cell load at each potential target cell for the current/predicted UE behaviour. Mobility analytics provide a list of target cells suitable for handover for load balancing or energy saving purposes. Once mobility analytics is received from all UEs in RRC_CONNECTED state at the gNB, the gNB can then choose the UEs for handover based on target cell current load values, i.e. in the load balancing case, target cells are chosen if the target cell load is less than a threshold.

Similar to load balancing, mobility analytics reporting can be used for the energy efficiency use case where a cell is lightly loaded, and the goal can be to handover the remaining connected UEs to other cells so that the cell can be switched off for energy saving. Energy Saving function can process the received mobility analytics reports to understand if all UEs have an available target cell to handover while maintaining the QoS and hence the cell can be switched off after the handover.

UEs can send mobility analytics report periodically until load balancing/energy saving load conditions disappear, and the cell can initiate the procedure defined earlier to stop mobility analytics reporting from the UEs.

In another embodiment, UEs can be configured to make regular inference on an AI model to detect any anomalies and send anomaly detection analytics report to the network when an anomaly is detected. AI models trained with historic UE behaviour will be able to differentiate abnormal UE behaviour such as unexpected QoS experience and report back to the network. These analytics can help to find abnormal UEs or fault finding at any network function.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

The above description is only an exemplary implementation of the present invention, and is not intended to limit the scope of protection of the present invention, which is determined by the appended claims.

According to an embodiment of the disclosure, a method of operating a User Equipment, UE, communicatively coupled to a telecommunication network is provided. The UE is arranged to make certain measurement in relation to the network, and to store the measurement results locally to the UE, wherein the UE is further arranged to not send the measurement results onto the network, thereby preserving privacy associated with the measurement results and to locally perform data analytics, inference or prediction using the measurement results.

According to another embodiment of the disclosure, wherein the analytics are obtained using an Artificial Intelligence, AI, model that is trained locally to the UE or globally by the network, but using local measurement data.

According to another embodiment of the disclosure, wherein the measurements include Minimization of Drive Tests (MDT) data.

According to another embodiment of the disclosure, wherein the UE is configured by the network to generate particular analytics reports by providing one or more of specific configurations, parameters, conditions and policies, to assist the UE in the generation of data analytics.

According to another embodiment of the disclosure, wherein the particular analytics reports include one of particular measurements, particular analytics and particular inference and predictions.

According to another embodiment of the disclosure, wherein the network provides the UE with assistance information on a validity time.

According to another embodiment of the disclosure, wherein the network provides information on requirements of the data analytics for the UE, said requirements including one or more of: size of data analytics, latency of data analytics, security requirements, accuracy and Key Performance Indicators (KPIs).

According to another embodiment of the disclosure, wherein the network may activate/deactivate or start, pause or stop the data analytics process at the UE.

According to another embodiment of the disclosure, wherein the UE utilises a communication module arranged to enable the UE, or a group of UEs, to share securely the generated data analytics reports to the network without sharing raw user data, thus preserving user privacy.

According to another embodiment of the disclosure, wherein the UE provides user consent to the network in connection with collecting analytics from the UE or sharing analytics beyond the UE.

According to another embodiment of the disclosure, wherein the UE indicates to the network its capability to support analytics to the network, such that the network is able to configure the data analytics collection and reporting, taking into consideration the indicated capability.

According to another embodiment of the disclosure, a method of operating a telecommunication network is provided. The method includes the step of configuring a UE to locally perform data analytics using certain measurement results, and to share a resulting data analytics report with the network without compromising user privacy.

According to another embodiment of the disclosure, the method comprises the use of a module to receive data analytics reports from the UE.

According to another embodiment of the disclosure, a UE arranged to perform the previously described methods is provided.

According to another embodiment of the disclosure, a telecommunication network arranged to perform the previously described method is provided.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

1. A method performed by a user equipment (UE) in a wireless communication system, the method comprising:
identifying at least one potential target cell for a handover based on mobility analytics information, by performing an artificial intelligence (AI) model inference;
transmitting, to a base station, information on a list of the at least one potential target cell for the handover; and
receiving, from the base station, information indicating the handover to a target cell among the at least one potential target cell.

2. The method of claim 1, wherein the mobility analytics information includes at least one of a minimization of driving test (MDT) measurement, a UE speed, a UE location, a handover performance, a handover failure rate, or an expected quality of service (QoS).

3. The method of claim 1, wherein the information on the at least one potential target cell is transmitted to the base station periodically or based on a triggering criterion.

4. The method of claim 1, wherein the UE is connected with the target cell for a load balancing or an energy saving.

5. A method performed by a base station in a wireless communication system, the method comprising:
receiving, from a user equipment (UE), information on a list of at least one potential target cell for a handover, wherein the at least one potential target cell for the handover is based on mobility analytics information for an artificial intelligence (AI) model inference; and
transmitting, to the UE, information indicating the handover to a target cell among the at least one potential target cell.

6. The method of claim 5, wherein the mobility analytics information includes at least one of a minimization of driving test (MDT) measurement, a UE speed, a UE location, a handover performance, a handover failure rate, or an expected quality of service (QoS).

7. The method of claim 5, wherein the information on the at least one potential target cell is received from the UE periodically or based on a triggering criterion, and
wherein the target cell is identified among the at least one potential target cell for a load balancing or an energy saving.

8. A user equipment (UE) in a wireless communication system, the UE comprising:
a transceiver; and
a controller coupled with the transceiver and configured to:
identify at least one potential target cell for a handover based on mobility analytics information, by performing an artificial intelligence (AI) model inference,
transmit, to a base station, information on a list of the at least one potential target cell for the handover, and
receive, from the base station, information indicating the handover to a target cell among the at least one potential target cell.

9. The UE of claim 8, wherein the mobility analytics information includes at least one of a minimization of driving test (MDT) measurement, a UE speed, a UE location, a handover performance, a handover failure rate, or an expected quality of service (QoS).

10. The UE of claim 8, wherein the information on the at least one potential target cell is transmitted to the base station periodically or based on a triggering criterion.

11. The UE of claim 8, wherein the UE is connected with the target cell for a load balancing or an energy saving.

12. A base station in a wireless communication system, the base station comprising:
a transceiver; and
a controller coupled with the transceiver and configured to:
receive, from a user equipment (UE), information on a list of at least one potential target cell for a handover, wherein the at least one potential target cell for the handover is based on mobility analytics information for an artificial intelligence (AI) model inference, and
transmit, to the UE, information indicating the handover to a target cell among the at least one potential target cell.

13. The base station of claim 12, wherein the mobility analytics information includes at least one of a minimization of driving test (MDT) measurement, a UE speed, a UE location, a handover performance, a handover failure rate, or an expected quality of service (QoS).

14. The base station of claim 12, wherein the information on the at least one potential target cell is received from the UE periodically or based on a triggering criterion.

15. The base station of claim 12, wherein the target cell is identified among the at least one potential target cell for a load balancing or an energy saving.
